(19) United States
(12) Patent Application Publication
(10) Pub. No.: US 2022/0198320 A1
(43) Pub. Date: Jun. 23, 2022

(54) MINIMIZING PROCESSING MACHINE LEARNING PIPELINING

(71) Applicant: International Business Machines Corporation, Armonk, NY (US)

(72) Inventors: John H. Walczyk, III, Raleigh, NC (US); Shuyan Lu, Cary, NC (US); Yi-Hui Ma, Mechanicsburg, PA (US)

(21) Appl. No.: 17/128,335

(22) Filed: Dec. 21, 2020

(51) Int. Cl. G06N 20/00; G06K 9/62

(52) U.S. Cl. CPC G06N 20/00; G06K 9/6218

(57) ABSTRACT

One or more computer processors determine a plurality of models to incorporate a plurality of determined features from a received dataset. The one or more computer processors generate an aggregated prediction utilizing each model, in parallel, in the determined plurality of models subject to stop criteria, wherein stop criteria includes a prediction duration threshold. The one or more computer processors calculate a confidence value for the aggregated prediction.

### BACKGROUND

The present invention relates generally to the field of machine learning, and more particularly to machine learning pipelining.

Machine learning (ML) is the scientific study of algorithms and statistical models that computer systems use to perform a specific task without using explicit instructions, relying on patterns and inference instead. Machine learning is seen as a subset of artificial intelligence. Machine learning algorithms build a mathematical model based on sample data, known as training data, in order to make predictions or decisions without being explicitly programmed to perform the task. Machine learning algorithms are used in a wide variety of applications, such as email filtering and computer vision, where it is difficult or infeasible to develop a conventional algorithm for effectively performing the task.

### SUMMARY

Embodiments of the present invention disclose a computer-implemented method, a computer program product, and a system. The computer-implemented method includes one or more computer processers determining a plurality of models to incorporate a plurality of determined features from a received dataset. The one or more computer processors generate an aggregated prediction utilizing each model, in parallel, in the determined plurality of models subject to stop criteria, wherein stop criteria includes a prediction duration threshold. The one or more computer processors calculate a confidence value for the aggregated prediction.

### BRIEF DESCRIPTION OF THE DRAWINGS

Figure (i.e., FIG. 1 is a functional block diagram illustrating a computational environment, in accordance with an embodiment of the present invention;

FIG. 2 is a flowchart depicting operational steps of a cognitive multi-pipeline control system, on a server computer within the computational environment of FIG. 1, for controlling multiple parallel-operating machine learning pipelines, where feature evaluation, model selection, and confidence scoring is performed in reduced time and with reduced computational resources, in accordance with an embodiment of the present invention; and

FIG. 3 is a block diagram of components of the server computer, in accordance with an embodiment of the present invention.

### DETAILED DESCRIPTION

Traditional automated decision-making ensemble systems have been successfully used to address a variety of machine learning problems, such as feature selection, confidence estimation, missing feature mitigation, etc. Often traditional automated decision-making ensemble systems are computational expensive, time consuming, and difficult to operate and control due to the extremely high volume of available data. Frequently, the quantity of available data produces ensemble systems that have prolonged and computationally intensive training and prediction cycles. During said cycles, associated systems require and retain large quantities of computational resources that could be utilized with other computational processes. Furthermore, known machine learning techniques require user intervention and lack the capability of automated and simultaneous application of the entire workflow for machine learning methods on data.

Embodiments of the present invention provide a method for controlling multiple parallel-operating machine learning pipelines where feature evaluation, model selection, and confidence scoring is performed in reduced time and with reduced computational resources. Embodiments of the present invention recognize that the utilization of stop criteria in machine learning pipelines produce high confidence predictions with reduced computational processing, features and subsequent model generations. Embodiments of the present invention generate conclusions from the results of an ensemble of maintained pipelines, while concurrently, allowing incomplete solutions from the maintained pipelines running in parallel. In this embodiment, the present invention identifies results sooner without requiring full processing of all the pipelines. Implementation of embodiments of the invention may take a variety of forms, and exemplary implementation details are discussed subsequently with reference to the Figures.

The present invention will now be described in detail with reference to the Figures.

FIG. 1 is a functional block diagram illustrating a computational environment, generally designated 100, in accordance with one embodiment of the present invention. The term “computational” as used in this specification describes a computer system that includes multiple, physically, distinct devices that operate together as a single computer system. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Computational environment 100 includes server computer 120 connected over network 102. Network 102 can be, for example, a telecommunications network, a local area network (LAN), a wide area network (WAN), such as the Internet, or a combination of the three, and can include wired, wireless, or fiber optic connections. Network 102 can include one or more wired and/or wireless networks that are capable of receiving and transmitting data, voice, and/or video signals, including multimedia signals that include voice, data, and video information. In general, network 102 can be any combination of connections and protocols that will support communications between server computer 120, and other computing devices (not shown) within computational environment 100. In various embodiments, network 102 operates locally via wired, wireless, or optical connections and can be any combination of connections and protocols (e.g., personal area network (PAN), near field communication (NFC), laser, infrared, ultrasonic, etc.).

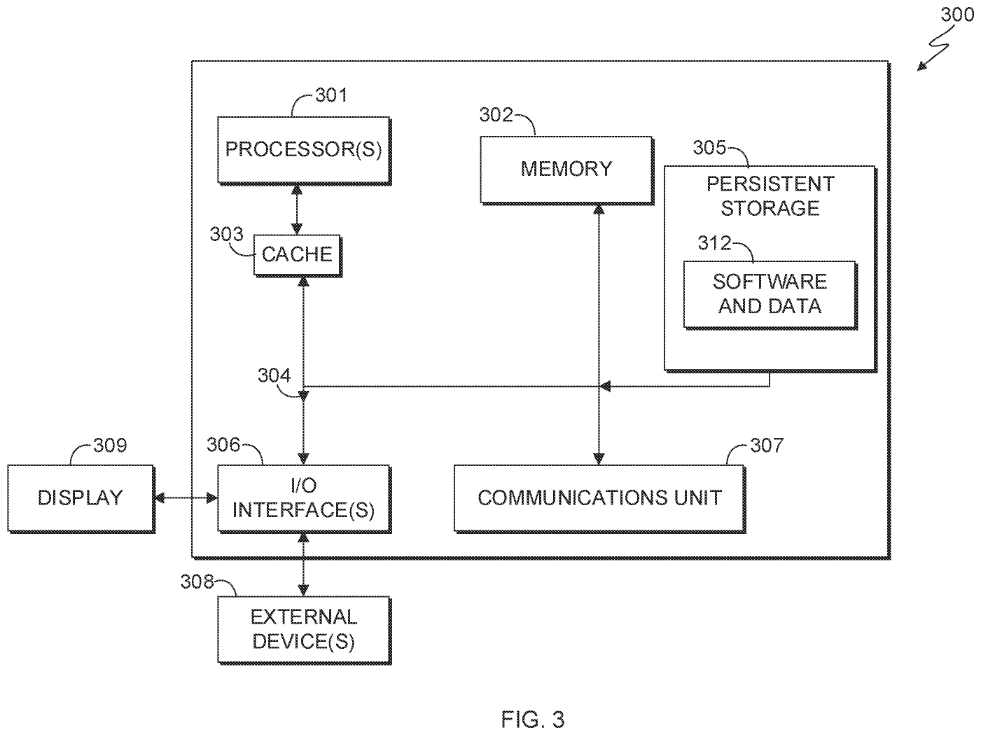

Server computer 120 can be a standalone computing device, a management server, a web server, a mobile computing device, or any other electronic device or computing system capable of receiving, sending, and processing data. In other embodiments, server computer 120 can represent a server computing system utilizing multiple computers as a server system, such as in a cloud computing environment. In another embodiment, server computer 120 can be a laptop computer, a tablet computer, a netbook computer, a personal computer (PC), a desktop computer, a personal digital assistant (PDA), a smart phone, or any programmable electronic device capable of communicating with other computing devices (not shown) within computational environment 100 via network 102. In another embodiment, server computer 120 represents a computing system utilizing clustered computers and components (e.g., database server computers, application server computers, etc.) that act as a single pool of seamless resources when accessed within computational environment 100. In the depicted embodiment, server computer 120 includes database 122 and program 150. In other embodiments, server computer 120 may contain other applications, databases, programs, etc. which have not been depicted in computational environment 100. Server computer 120 may include internal and external hardware components, as depicted and described in further detail with respect to FIG. 3.

Database 122 is a repository for data used by program 150. In the depicted embodiment, database 122 resides on server computer 120. In another embodiment, database 122 may reside elsewhere within computational environment 100 provided program 150 has access to database 122. A database is an organized collection of data. Database 122 can be implemented with any type of storage device capable of storing data and configuration files that can be accessed and utilized by program 150, such as a database server, a hard disk drive, or a flash memory. In an embodiment, database 122 stores data used by program 150, such as historical predictions, confidence scores, features, etc. In the depicted embodiment, database 122 contains corpus 124.

Corpus 124 contains one or more datapoints, sets of training data, data structures, and/or variables used to fit the parameters of a specified model. The contained data comprises of pairs of input vectors with associated output vectors. In an embodiment, corpus 124 may contain one or more sets of one or more instances of unclassified or classified (e.g., labelled) data, hereinafter referred to as training statements. In another embodiment, the training data contains an array of training statements organized in labelled training sets. For example, a plurality of training sets include “positive” and “negative” labels paired with associated training statements (e.g., words, sentences, etc.). In an embodiment, each training set includes a label and an associated array or set of training statements which can be utilized to train one or more models. In an embodiment, corpus 124 contains unprocessed training data. In an alternative embodiment, corpus 124 contains natural language processed (NLP) (e.g., section filtering, sentence splitting, sentence tokenizer, part of speech (POS) tagging, tf-idf, etc.) feature sets. In a further embodiment, corpus 124 contains vectorized (i.e., one-hot encoding, word embedded, dimension reduced, etc.) training sets, associated training statements, and labels.

Models 130 contains a plurality of models utilizing deep learning techniques to train, calculate weights, ingest inputs, and output a plurality of solution vectors. In an embodiment, models 130 may include any number of and/or combination of models and model types. Models 130 is representative of a plurality of deep learning models, techniques, and algorithms (e.g., decision trees, Naive Bayes classification, support vector machines for classification problems, random forest for classification and regression, linear regression, least squares regression, logistic regression). In an embodiment, models 130 utilize transferrable neural networks algorithms and models (e.g., long short-term memory (LSTM), deep stacking network (DSN), deep belief network (DBN), convolutional neural networks (CNN), compound hierarchical deep models, etc.) that can be trained with supervised or unsupervised methods. In an embodiment, each model in models 130 has a distinctive training duration, processing (e.g., prediction) duration, and confidence value.

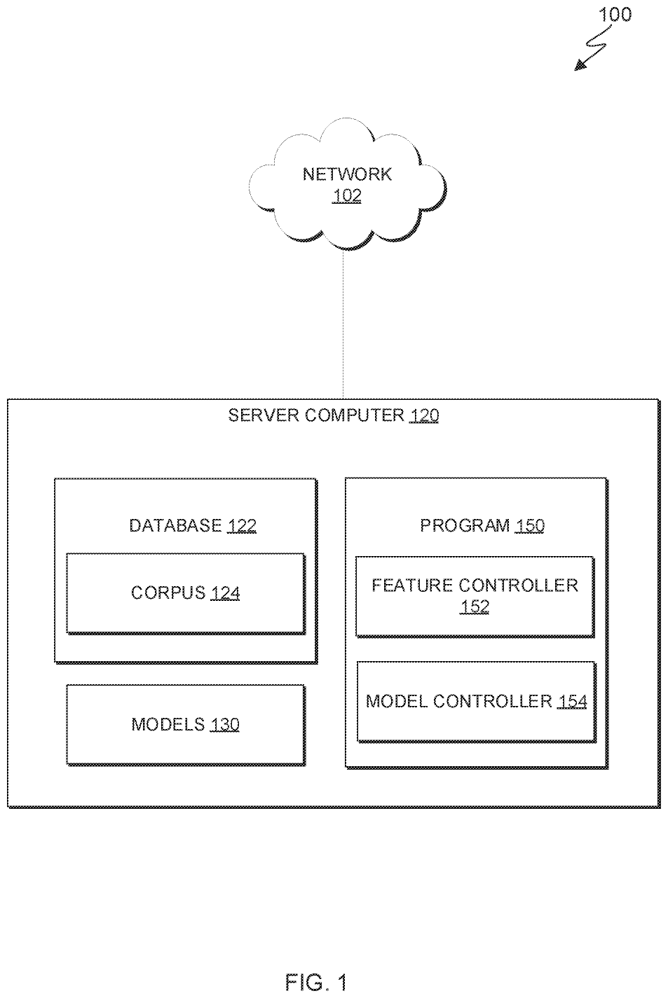

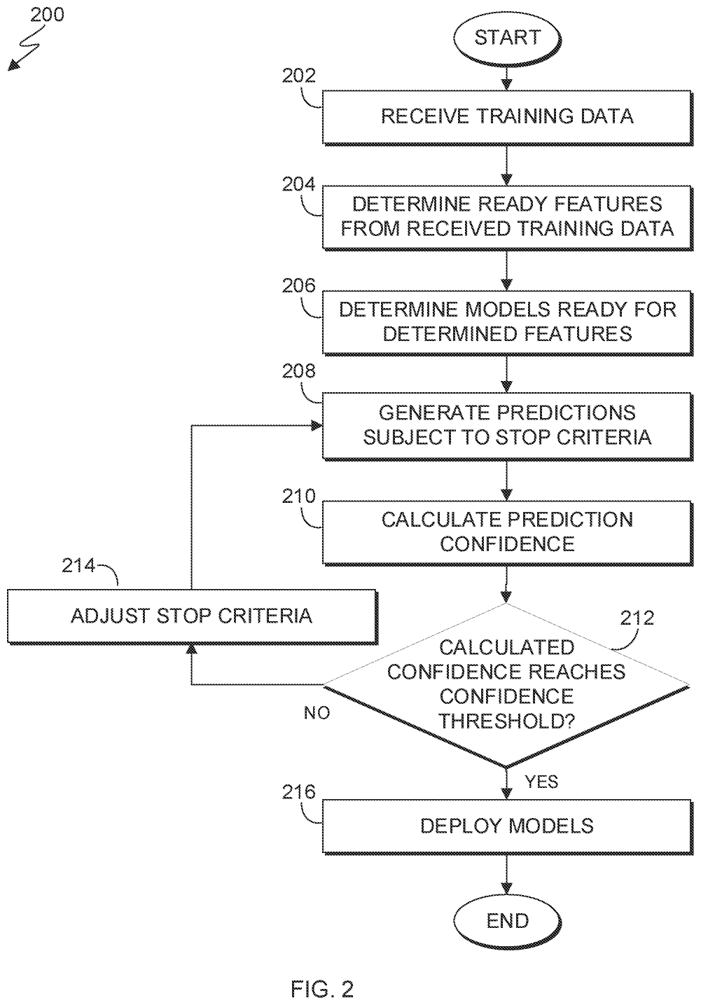

Program 150 is a cognitive multi-pipeline control system controlling multiple parallel-operating machine learning pipelines where feature evaluation, model selection, and confidence scoring are performed in reduced time and with reduced computational resources. In an embodiment, program 150 (i.e., analytical brain) is a multi-pipeline controller that utilizes stop criteria to determine whether to activate or deactivate a particular pipeline path. In this embodiment, program 150 generates confidence scores of the ensemble of pipelined models. In an embodiment, program 150 utilizes a publish and subscribe structure architecture pattern to monitor the determined ensemble utilizing an asynchronous messaging service to communicate model states and events in the pipeline lifecycle, such as dead, blocked, or running processes. In various embodiments, program 150 may implement the following steps: determine a plurality of models to incorporate a plurality of determined features from a received dataset; generate an aggregated prediction utilizing each model, in parallel, in the determined plurality of models subject to stop criteria, wherein stop criteria includes a prediction duration threshold; and a confidence value for the aggregated prediction. In the depicted embodiment, program 150 is a standalone software program. In another embodiment, the functionality of program 150, or any combination programs thereof, may be integrated into a single software program. In some embodiments, program 150 may be located on separate computing devices (not depicted) but can still communicate over network 102. In various embodiments, client versions of program 150 resides on any other computing device (not depicted) within computational environment 100. In the depicted embodiment, program 150 includes feature controller 152 and model controller 154. Feature controller 152 records feature readiness and controls model calculations. Model controller 154 evaluates the aggregation of a plurality of model predictions. In an embodiment, model controller 154 utilizes heuristics and rule prediction structures to record a model readiness and determine an ensemble prediction utilizing evaluated aggregations. In this embodiment, model controller 154 utilizes ensemble methods to obtain increased predictive performance than could be obtained from any constituent models. Program 150 is depicted and described in further detail with respect to FIG. 2.

The present invention may contain various accessible data sources, such as database 122 and corpus 124, that may include personal storage devices, data, content, or information the user wishes not to be processed. Processing refers to any, automated or unautomated, operation or set of operations such as collection, recording, organization, structuring, storage, adaptation, alteration, retrieval, consultation, use, disclosure by transmission, dissemination, or otherwise making available, combination, restriction, erasure, or destruction performed on personal data. Program 150 provides informed consent, with notice of the collection of personal data, allowing the user to opt in or opt out of processing personal data. Consent can take several forms. Opt-in consent can impose on the user to take an affirmative action before the personal data is processed. Alternatively, opt-out consent can impose on the user to take an affirmative action to prevent the processing of personal data before the data is processed. Program 150 enables the authorized and secure processing of user information, such as tracking information, as well as personal data, such as personally identifying information or sensitive personal information. Program 150 provides information regarding the personal data and the nature (e.g., type, scope, purpose, duration, etc.) of the processing. Program 150 provides the user with copies of stored personal data. Program 150 allows the correction or completion of incorrect or incomplete personal data. Program 150 allows the immediate deletion of personal data.

FIG. 2 depicts flowchart 200 illustrating operational steps of program 150 for controlling multiple parallel-operating machine learning pipelines where feature evaluation, model selection, and confidence scoring is performed in reduced time and with reduced computational resources, in accordance with an embodiment of the present invention.

Program 150 receives training data (step 202). In an embodiment, program 150 initiates responsive to a user commencement of a machine learning pipeline. In another embodiment, program 150 commences responsive to a detected or received set of training data from corpus 124. In an embodiment, program 150 continuously initiates machine learning pipelines in response to continuously streaming data (e.g., training data or unlabeled data). In yet another embodiment, program 150 constructs a plurality of training subsets by segmenting the training data into discrete section, subject, or categorical sets. In various embodiments, program 150 utilizes cross validation techniques, such as K-Fold cross validation, to create one or more testing and validation sets. In an embodiment, program 150, responsively, vectorizes the partitioned training sets, where vectorization transforms iterative operations into matrix operations, allowing modern central processing unit (CPU) acceleration of machine learning and deep learning operations.

Program 150 determines ready features from the received training data (step 204). In an embodiment, program 150 identifies a plurality of features contained in the received training data through a feature identification process, such as a statistical-based feature selection method that evaluates the relationship between each input variable and the target variable. For example, program 150 utilizes information gain to calculate a reduction in entropy from the transformation of a dataset, where program 150 calculates the information gain of each feature in the context of the target feature. In an embodiment, program 150 utilizes feature controller 152 to determine the features ready to be incorporated into models 130. For example, feature controller 152 selects a subset of identified features that reach an information gain threshold to subsequently train models 130. In an embodiment, program 150 utilizes featuring scaling techniques (e.g., rescaling, mean normalization, etc.) to normalize feature sets.

Program 150 determines models ready for the determined features (step 206). In an embodiment, program 150 initializes models 130 with one or more weights and associated hyperparameters. In an embodiment, program 150 initializes models 130 with randomly generated weights. In an alternative embodiment, program 150 initializes models 130 with weights calculated from the analysis described above. In various embodiments, program 150 utilizes weights utilized in historical or previously iterated/trained models. In this embodiment, certain features are weighted higher than others allowing the model to learn at a quicker rate with fewer computational resources. For example, the weights of a previously trained model, that failed to exceed a confidence threshold, are utilized in a subsequent retraining iteration. In an embodiment, the user may specify a training method to utilize such as unsupervised training, etc. In the depicted embodiment, program 150 utilizes received training data, as described in step 202, and determined features, as described in step 204, to perform supervised training of models 130. As would be recognized by one skilled in the art, supervised training determines the difference between a prediction and a target (i.e., the error), and back-propagates the difference through the layers such that said model learns. In an embodiment, program 150 receives an ensemble of models 130 from a prior training or prediction cycle. In this embodiment, program 150 removes one or more models from the ensemble if the accuracy of said models do not meet a confidence threshold. In another embodiment, program 150 retrains models that do not meet a confidence threshold.

Program 150 generates predictions subject to stop criteria (step 208). In an embodiment, program 150 utilizes a plurality of test or validation sets to generate a plurality of predictions utilizing models 130, where each model in models 130, concurrently, generates a prediction (e.g., probability, classification, value, etc.). In another embodiment, program 150 processes, vectorizes, and feeds unlabeled datapoints into models 130. In a further embodiment, program 150 utilizes stop criteria to determine when to collect predictions and stop models that have not provided a prediction. In an embodiment, program 150 utilizes stop criteria to establish and adjust a prediction duration threshold. For example, program 150 utilizes stop criteria dictating that a model must return a prediction within five minutes of initiation. In an embodiment, stop criteria are predetermined (e.g., historical average prediction duration) or provided by a user or organization. In various embodiments, program 150 applies stop criteria on a global basis for models 130, where every model in models 130 is constrained by the same stop criteria regardless of underlying model structure. In another embodiment, program 150 applies stop criteria on a model level, where every model in models 130 has distinctive stop criteria specific to underlying model structure. In an embodiment, program 150 aggregates all predictions from each model subject to stop criteria. In this embodiment, program 150 utilizes available predictions while ignoring pipelines (i.e., models) that fail or take too long (i.e., stop criteria). This embodiment aggregates a prediction from the results of many pipelines, similar to an ensemble, but with the exception of not requiring complete solutions from models 130 running in parallel. In a further embodiment, stop criteria include training duration thresholds, pipeline duration thresholds, and computational limitations (e.g., CPU restrictions).

Program 150 calculates prediction confidence (step 210). In an embodiment, program 150 calculates a prediction confidence value or score for the aggregated predictions from step 208. Program 150 generates a confidence score with any set of aggregated model predictions allowing program 150 to mitigate missing model predictions. In this embodiment, program 150 determines whether a sufficient accuracy is obtained by utilizing test/validation sets and the associated test labels. In another embodiment, program 150 utilizes cross-entropy (e.g., Kullback-Leibler (KL) divergence, etc.) as a loss function to determine the level of prediction accuracy. In this embodiment, program 150 compares a predicted sequence with an expected sequence. In a further embodiment, program 150 generates prediction, global ensemble and local model, statistics including, but not limited to, predictive accuracy (e.g., Brier scores, Gini coefficients, discordant ratios, C-statistic values, net reclassification improvement indexes, receiver operating characteristics, generalized discrimination measures, Hosmer-Lemeshow goodness of fit values, etc.), error rates (e.g., root mean squared error (RMSE), mean absolute error, mean absolute percentage error, mean percentage error, etc.), precision, overfitting considerations, model fitness, and related system statistics (e.g., memory utilization, CPU utilization, storage utilization, etc.).

If calculated confidence does not reach a confidence threshold, then program 150 (“no” branch, decision block 212), program 150 adjusts stop criteria of models (step 214). Program 150 compares the calculated prediction confidence score from step 210 to a predetermined confidence threshold (e.g., greater or equal to 90% confidence). Responsive to the calculated prediction confidence score not reaching the confidence threshold, program 150 calculates a deviation (e.g., gap) value between current predictions/models and historical predictions/models. This embodiment is similar to optimization algorithms that approach local minimum, but here, the present invention approaches deviation value local minimum (e.g., balancing computational time with predictive accuracy) in multiple directions. In this embodiment, program 150 adjusts stop criteria to allow for more collected predictions. For example, program 150 increases a prediction duration to allow for slower and computationally intensive models to finish predictions to contribute to the aggregated (i.e., ensemble) prediction.

In an embodiment, program 150 utilizes one or more clustering methods and/or algorithms (e.g., binary classifiers, multi-class classifiers, multi-label classifiers, Naïve Bayes, k-nearest neighbors, random forest, etc.) to create a plurality of clusters representing a high level view of the predictions and associated models. In this embodiment, program 150 utilizes the clustering methods to identify predictions and models with relatively high confidence scores. For example, program 150 utilizes clustering to group models that have accurate predictions even though the aggregated prediction was inaccurate. In an embodiment, program 150 utilizes a classification model to identify and assign a label to created clusters. In a further embodiment, program 150 utilizes the clustered models to adjust the ensemble by adding, removing, or retraining one or more models. For example, program 150 creates a new ensemble with models that have identified high confidence predictions, while retraining the remaining models. In a further embodiment, program 150 adjusts associated stop criteria to allow sufficient time for the high confidence models to produce high confidence prediction while keeping prediction duration to a minimum. In another embodiment, program 150 adjusts stop criteria to allow lower performing models to increase computational resources. In a further embodiment, program 150 continues to adjust stop criteria until a highly confidence ensemble is produced with minimal training and prediction durations with reduced computational requirements.

If calculated confidence reaches a confidence threshold, then program 150 (“yes” branch, decision block 212), program 150 deploys the models (step 216). In an embodiment, program 150 deploys high confidence models 130 to a plurality of production, test, and auxiliary environments. In an embodiment, said testing environments are structured and created to mimic associated production environments. In this embodiment, said testing environments duplicate system/computational resources, system tools/programs, and dependencies available to an associated production environment. In another embodiment, test and auxiliary environments are structurally, systemically, and programmatically indistinguishable from production environments. In various embodiments, program 150 utilizes deployed models 130 as an ensemble to predict subsequent unknown (e.g., unlabeled) datapoints. In a further embodiment, program 150 adjusts stop criteria based on the deployed models, as described in step 214.

FIG. 3 depicts block diagram 300 illustrating components of server computer 120 in accordance with an illustrative embodiment of the present invention. It should be appreciated that FIG. 3 provides only an illustration of one implementation and does not imply any limitations with regard to the environments in which different embodiments may be implemented. Many modifications to the depicted environment may be made.

Server computer 120 each include communications fabric 304, which provides communications between cache 303, memory 302, persistent storage 305, communications unit 307, and input/output (I/O) interface(s) 306. Communications fabric 304 can be implemented with any architecture designed for passing data and/or control information between processors (such as microprocessors, communications, and network processors, etc.), system memory, peripheral devices, and any other hardware components within a system. For example, communications fabric 304 can be implemented with one or more buses or a crossbar switch.

Memory 302 and persistent storage 305 are computer readable storage media. In this embodiment, memory 302 includes random access memory (RAM). In general, memory 302 can include any suitable volatile or non-volatile computer readable storage media. Cache 303 is a fast memory that enhances the performance of computer processor(s) 301 by holding recently accessed data, and data near accessed data, from memory 302.

Program 150 may be stored in persistent storage 305 and in memory 302 for execution by one or more of the respective computer processor(s) 301 via cache 303. In an embodiment, persistent storage 305 includes a magnetic hard disk drive. Alternatively, or in addition to a magnetic hard disk drive, persistent storage 305 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 305 may also be removable. For example, a removable hard drive may be used for persistent storage 305. Other examples include optical and magnetic disks, thumb drives, and smart cards that are inserted into a drive for transfer onto another computer readable storage medium that is also part of persistent storage 305. Software and data 312 can be stored in persistent storage 305 for access and/or execution by one or more of the respective processors 301 via cache 303.

Communications unit 307, in these examples, provides for communications with other data processing systems or devices. In these examples, communications unit 307 includes one or more network interface cards. Communications unit 307 may provide communications through the use of either or both physical and wireless communications links. Program 150 may be downloaded to persistent storage 305 through communications unit 307.

I/O interface(s) 306 allows for input and output of data with other devices that may be connected to server computer 120. For example, I/O interface(s) 306 may provide a connection to external device(s) 308, such as a keyboard, a keypad, a touch screen, and/or some other suitable input device. External devices 308 can also include portable computer readable storage media such as, for example, thumb drives, portable optical or magnetic disks, and memory cards. Software and data used to practice embodiments of the present invention, e.g., program 150, can be stored on such portable computer readable storage media and can be loaded onto persistent storage 305 via I/O interface(s) 306. I/O interface(s) 306 also connect to a display 309.

Display 309 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, conventional procedural programming languages, such as the “C” programming language or similar programming languages, and quantum programming languages such as the “Q” programming language, Q#, quantum computation language (QCL) or similar programming languages, low-level programming languages, such as the assembly language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method comprising:
determining, by one or more computer processors, a plurality of models to incorporate a plurality of determined features from a received dataset;
generating, by one or more computer processors, an aggregated prediction utilizing each model, in parallel, in the determined plurality of models subject to stop criteria, wherein stop criteria includes a prediction duration threshold; and
calculating, by one or more computer processors, a confidence value for the aggregated prediction.

2. The computer-implemented method of claim 1, further comprising:
responsive to the calculated confidence value for the aggregated prediction not reaching a confidence threshold, adjusting, by one or more computer processors, the stop criteria to allow for greater prediction duration; and
generating, by one or more computer processors, the aggregated prediction utilizing each model in the determined plurality of models subject to adjusted stop criteria.

3. The computer-implemented method of claim 1, further comprising:
responsive to the calculated confidence value for the aggregated prediction reaching a confidence threshold, deploying, by one or more computer processors, the plurality of models.

4. The computer-implemented method of claim 3, further comprising:
labeling, by one or more computer processors, one or more unlabeled datapoints with the deployed plurality of models.

5. The computer-implemented method of claim 1, wherein determining the plurality of models to incorporate the plurality of determined features from the received dataset, comprises:
training, by one or more computer processors, the plurality of models utilizing the determined features and associated training data.

6. The computer-implemented method of claim 2, further comprising:
clustering, by one or more computer processors, the plurality of models; and
identifying, by one or more computer processors, one or more models with high confidence predictions utilizing the clustered plurality of models.

7. The computer-implemented method of claim 1, further comprising:
monitoring, by one or more computer processors, one or more models utilizing a publish and subscribe structure.

8. A computer program product comprising:
one or more computer readable storage media and program instructions stored on the one or more computer readable storage media, the stored program instructions comprising:
program instructions to determine a plurality of models to incorporate a plurality of determined features from a received dataset;
program instructions to generate an aggregated prediction utilizing each model, in parallel, in the determined plurality of models subject to stop criteria, wherein stop criteria includes a prediction duration threshold; and
program instructions to calculate a confidence value for the aggregated prediction.

9. The computer program product of claim 8, wherein the program instructions, stored on the one or more computer readable storage media, further comprise:
program instructions to, responsive to the calculated confidence value for the aggregated prediction not reaching a confidence threshold, adjust the stop criteria to allow for greater prediction duration; and
program instructions to generate the aggregated prediction utilizing each model in the determined plurality of models subject to adjusted stop criteria.

10. The computer program product of claim 8, wherein the program instructions, stored on the one or more computer readable storage media, further comprise:
program instructions to, responsive to the calculated confidence value for the aggregated prediction reaching a confidence threshold, deploy the plurality of models.

11. The computer program product of claim 10, wherein the program instructions, stored on the one or more computer readable storage media, further comprise:
program instructions to label one or more unlabeled datapoints with the deployed plurality of models.

12. The computer program product of claim 8, wherein the program instructions to determine the plurality of models to incorporate the plurality of determined features from the received dataset, comprise:
program instructions to train the plurality of models utilizing the determined features and associated training data.

13. The computer program product of claim 9, wherein the program instructions, stored on the one or more computer readable storage media, further comprise:
program instructions to cluster the plurality of models; and
program instructions to identify one or more models with high confidence predictions utilizing the clustered plurality of models.

14. The computer program product of claim 8, wherein the program instructions, stored on the one or more computer readable storage media, further comprise:
program instructions to monitor one or more models utilizing a publish and subscribe structure.

15. A computer system comprising:
one or more computer processors;
one or more computer readable storage media; and
program instructions stored on the computer readable storage media for execution by at least one of the one or more processors, the stored program instructions comprising:
program instructions to determine a plurality of models to incorporate a plurality of determined features from a received dataset;
program instructions to generate an aggregated prediction utilizing each model, in parallel, in the determined plurality of models subject to stop criteria, wherein stop criteria includes a prediction duration threshold; and
program instructions to calculate a confidence value for the aggregated prediction.

16. The computer system of claim 15, wherein the program instructions, stored on the one or more computer readable storage media, further comprise:
program instructions to, responsive to the calculated confidence value for the aggregated prediction not reaching a confidence threshold, adjust the stop criteria to allow for greater prediction duration; and
program instructions to generate the aggregated prediction utilizing each model in the determined plurality of models subject to adjusted stop criteria.

17. The computer system of claim 15, wherein the program instructions, stored on the one or more computer readable storage media, further comprise:
program instructions to, responsive to the calculated confidence value for the aggregated prediction reaching a confidence threshold, deploy the plurality of models.

18. The computer system of claim 17, wherein the program instructions, stored on the one or more computer readable storage media, further comprise:
program instructions to label one or more unlabeled datapoints with the deployed plurality of models.

19. The computer system of claim 15, wherein the program instructions to determine the plurality of models to incorporate the plurality of determined features from the received dataset, comprise:
program instructions to train the plurality of models utilizing the determined features and associated training data.

20. The computer system of claim 15, wherein the program instructions, stored on the one or more computer readable storage media, further comprise:
program instructions to cluster the plurality of models; and
program instructions to identify one or more models with high confidence predictions utilizing the clustered plurality of models.
